(19) United States
(12) Patent Application Publication
(10) Pub. No.: US 2008/0120114 A1
(43) Pub. Date: May 22, 2008

(54) Method, Apparatus and Computer Program Product for Performing Stereo Adaptation for Audio Editing

(75) Inventor: Juha Ojanpera, Nokia (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/561,472

(22) Filed: Nov. 20, 2006

(51) Int. Cl. G11B 27/031

(52) U.S. Cl. 704/278; 704/E21.017

(57) ABSTRACT

An apparatus for performing stereo adaptation for audio editing includes a stereo decorrelator configured to receive a stereo audio frame in a compressed domain. The stereo audio frame includes a first channel and a second channel. The stereo decorrelator includes a bandwidth limitation element configured to receive a user input defining a desired editing operation to be performed with respect to one of the first and second channels in the compressed domain, and to limit a bandwidth of the other of the first and second channels based on the user input.

### TECHNOLOGICAL FIELD

Embodiments of the present invention relate generally to multimedia content editing technology and, more particularly, relate to a method, apparatus, and computer program product for providing stereo adaptation for audio editing.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, etc. The services may also be in the form of interactive applications in which the user may respond to a network device in order to perform a task or achieve a goal or in the form of content sharing applications which allow a user to receive or share content from or with friends or other individuals. The services may be provided from a network server or other network device, or even from the mobile terminal such as, for example, a mobile telephone, a mobile television, a mobile gaming system, etc.

In many content sharing applications, it may be desirable for the receiver of the content to edit the content received. The editing may be performed, for example, in order to reduce the size of the content or to personalize the content. Most content editing applications share a common set of elementary audio editing operations such as cut/paste, fade in/out, mixing, etc. Other common operations may include level alignment, dynamic range control, equalization, noise reduction, spatial and other effects. In many applications, services are included for extraction of content and coding related parameters (e.g., sampling rate, channel configuration, bitrate, etc.).

In conventional content sharing applications that offer editing functions, it is typical for compressed audio to be decoded prior to performing editing operations and then re-encoded. In other words, audio is typically subject to tandem coding in which audio is decoded from the compressed domain into the uncompressed domain for the performance of editing, and then re-encoded back in to the compressed domain after editing has been completed. This conventional method, however, requires a relatively large amount of processing, and with lossy compression techniques (i.e., compression techniques that degrade quality) there is typically an increase in quality degradation due to tandem coding.

Accordingly, it may be desirable to introduce a mechanism by which audio editing may be performed such that the deficiencies described above may be overcome.

### BRIEF SUMMARY

A method, apparatus and computer program product are therefore provided for performing stereo adaptation for audio editing in the compressed domain. According to exemplary embodiments of the present invention, audio editing may be performed in the compressed domain in order to avoid the potential of tandem coding with respect to audio editing functions. In one exemplary embodiment, a stereo panning processing may be performed in the compressed domain and fast requantization may be performed utilizing only scale factor differences as described below. Bandwidth limitation and reduction in selected quantized values may also be performed upon the channel opposite a desired direction of stereo image shift based on a user input. Accordingly, when moving a stereo image to the left or right stereo channels, such movement may be performed upon compressed stereo frames which may then be stored as a file. Therefore, processing power may be reduced since there is no requirement for decompressing and re-compressing data prior to processing.

In one exemplary embodiment, a method of providing stereo adaptation is provided. The method includes receiving a stereo audio frame in a compressed domain. The stereo audio frame includes a first channel and a second channel. The method also includes receiving a user input defining a desired editing operation to be performed with respect to one of the first and second channels in the compressed domain and limiting a bandwidth of the other of the first and second channels based on the user input.

In another exemplary embodiment, a computer program product for providing stereo adaptation is provided. The computer program product includes at least one computer-readable storage medium having computer-readable program code portions stored therein. The computer-readable program code portions include first, second and third executable portions. The first executable portion is for receiving a stereo audio frame in a compressed domain. The stereo audio frame includes a first channel and a second channel. The second executable portion is for receiving a user input defining a desired editing operation to be performed with respect to one of the first and second channels in the compressed domain. The third executable portion is for limiting a bandwidth of the other of the first and second channels based on the user input.

In another exemplary embodiment, an apparatus for providing stereo adaptation is provided. The apparatus includes a stereo decorrelator configured to receive a stereo audio frame in a compressed domain. The stereo audio frame includes a first channel and a second channel. The stereo decorrelator includes a bandwidth limitation element configured to receive a user input defining a desired editing operation to be performed with respect to one of the first and second channels in the compressed domain, and to limit a bandwidth of the other of the first and second channels based on the user input.

In another exemplary embodiment, an apparatus for providing stereo adaptation is provided. The apparatus includes means for receiving a stereo audio frame in a compressed domain. The stereo audio frame includes a first channel and a second channel. The apparatus also includes means for receiving a user input defining a desired editing operation to be performed with respect to one of the first and second channels in the compressed domain and means for limiting a bandwidth of the other of the first and second channels based on the user input.

Embodiments of the invention may provide a method, apparatus and computer program product for employment in content editing applications. Embodiments of the present invention may be used, for example, in advanced audio coding (AAC) and enhanced AACPlus (AAC+) encoders in order to deliver decorrelated quantized samples to a bitstream re-multiplexer as part of a content editing process. As a result, for example, mobile terminals and other electronic devices may benefit from reduced consumption of processing power while performing audio editing such as stereo panning.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of portions of an apparatus for providing stereo adaptation for stereo panning according to an exemplary embodiment of the present invention;

FIG. 4 illustrates a block diagram of a stereo decorrelator according to an exemplary embodiment of the present invention; and

FIG. 5 is a block diagram according to an exemplary method for providing stereo adaptation for audio editing according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

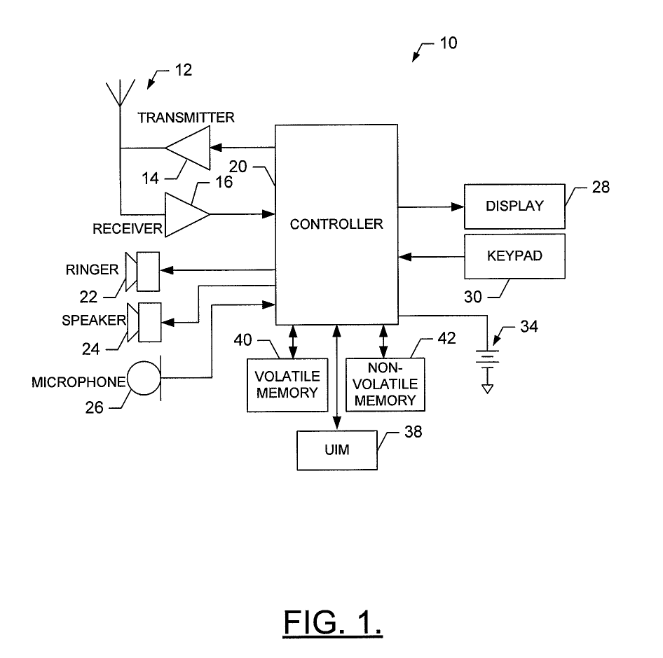

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

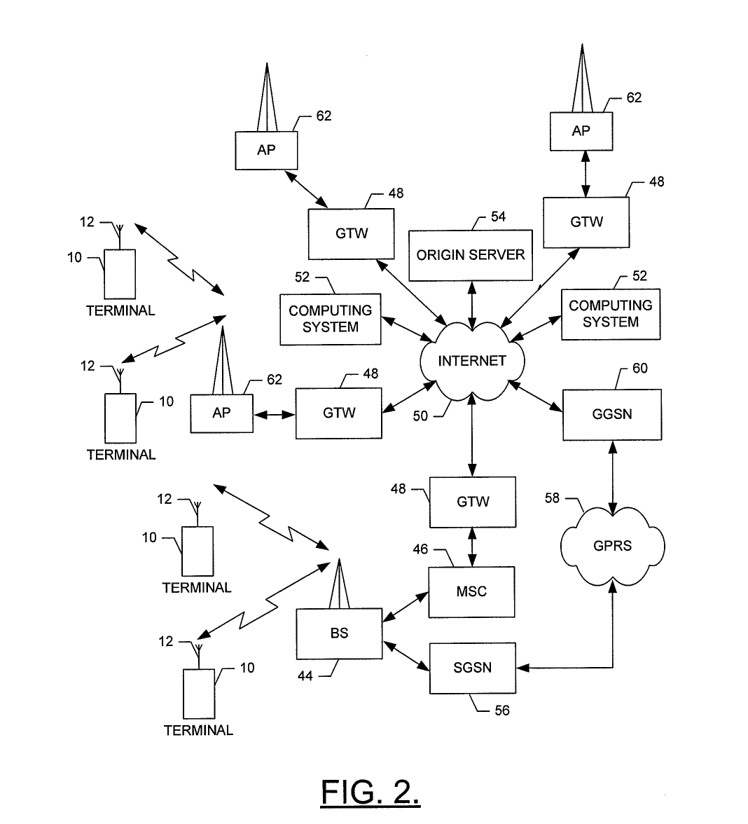

Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

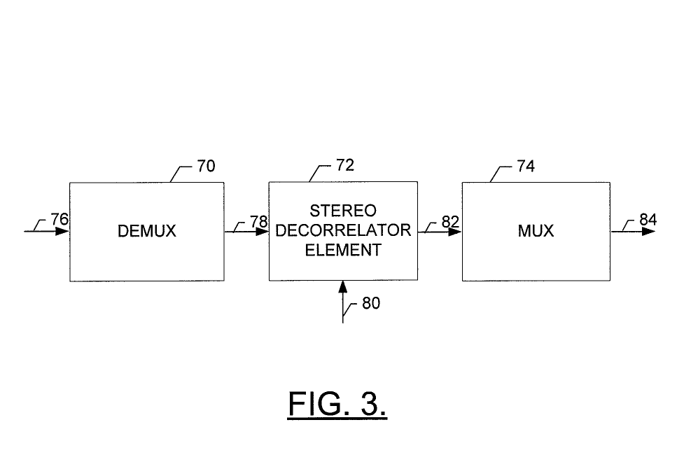

In an exemplary embodiment, content may be shared over the system of FIG. 2 between different mobile terminals, any of which may be similar to the mobile terminal 10 of FIG. 1. An exemplary embodiment of the invention will now be described with reference to FIG. 3, in which certain elements of an apparatus for providing stereo adaptation for audio editing are displayed. The apparatus of FIG. 3 may be employed, for example, on the mobile terminal 10 of FIG. 1. However, it should be noted that the apparatus of FIG. 3, may also be employed on a variety of other devices, both mobile and fixed, and therefore, embodiments of the present invention should not be limited to application on devices such as the mobile terminal 10 of FIG. 1. It should also be noted, that while FIG. 3 illustrates one example of a configuration of an apparatus for providing stereo adaptation for audio editing, numerous other configurations may also be used to implement embodiments of the present invention. Furthermore, although FIG. 3 will be described in the context of stereo panning to illustrate an exemplary embodiment, other embodiments of the present invention need not necessarily be practiced in the context of stereo panning, but instead apply more generally to any stereo adaptation function. Examples of other stereo adaptation functions include, for example, putting one content on one channel and different content on the other channel and reducing file size by dropping a channel from the frame structure if no correlation exists between the channels.

As is well known, stereo audio signals include separate data corresponding to a first channel and a second channel, which are commonly referred to as left and right stereo channels. A stereo panning processing function (or stereo panning) moves a stereo image either to the left or right stereo channel which is perceived as a shift of the corresponding sound more to the left or right, respectively. Conventional stereo coding methods, such as N/S (Mid/Side) and IS (Intensity Stereo) coding, utilize correlations that exist between the left and right channels in order to reduce bitrate and maintain relatively constant high quality. In M/S stereo, the left and right channels are transformed into sum and difference signals. To increase coding efficiency, the transformation is performed in both frequency and time dependent manners. M/S stereo is recognized as providing relatively high quality and high bitrate stereo encoding. In an attempt to achieve lower stereo bitrates, IS stereo has typically been used in combination with M/S coding. In IS coding, a portion of the spectra of a signal is coded only in mono mode and a stereo image is reconstructed by transmitting different scaling factors for the left and right channels. IS stereo is generally recognized as exhibiting poor performance at low frequencies thereby limiting the useable bitrate range.

According to embodiments of the present invention, it may be beneficial, although not necessary, to remove M/S and IS coding prior to performing the stereo panning as disclosed herein. In this regard, the stereo panning effect may be realized by adjusting dequantizer step size values that are transmitted in a stereo signal bitstream. Quantized samples are typically transmitted in a correlated format, but for stereo panning in accordance with an exemplary embodiment of the present invention, the quantized samples may be un-correlated in the bitstream as described in greater detail below.

Referring now to FIG. 3, an apparatus for providing stereo adaptation for audio editing is provided. The apparatus includes a de-multiplexer 70, a stereo decorrelator element 72, and a multiplexer 74. In an exemplary embodiment, each of the de-multiplexer 70, the stereo decorrelator element 72, and the multiplexer 74 may operate under the control of a processing element such as, for example, the controller 20 of FIG. 1. Each of the de-multiplexer 70, the stereo decorrelator element 72, and the multiplexer 74 may be any device or means embodied in either hardware, software, or a combination of hardware and software capable of performing the respective functions associated with each of the corresponding elements as described in greater detail below.

The de-multiplexer 70 may be any known de-multiplexer (DEMUX) capable of splitting mixed signals in accordance with methods well known in the art. In an exemplary embodiment, the de-multiplexer 70 may receive an input bitstream 76 which may include a compressed stereo signal having left and right channels. In response to receipt of the input bitstream 76, the de-multiplexer 70 may be configured to split the input bitstream 76 into a de-multiplexed signal 78 including separated left and right channels. The de-multiplexed signal 78 may also include parameters extracted from the input bitstream 76 associated with each of the left and right channels. The parameters may include quantized values such as quantizer step size information and stereo signaling information for each spectral band.

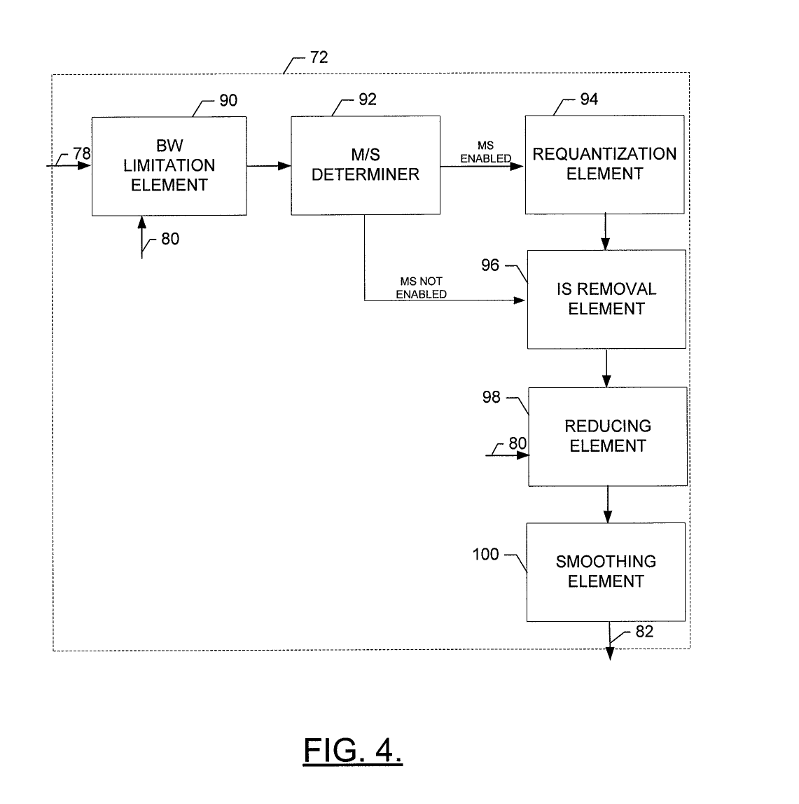

In an exemplary embodiment, the stereo decorrelator element 72 may be configured to provide stereo adaptation such as stereo panning for the left and/or right channels of the de-multiplexed signal 78 based on a user input 80 as described in greater detail below. In this regard, according to an exemplary embodiment, the user input 80 may be a user selected gain (e.g., a stereo panning gain) which defines an amount of stereo image change (i.e., shift of the stereo image to the right or left) desired by the user. In an exemplary embodiment, based on the user input 80, the decorrelator element 72 may be configured to provide a change in the quantizer step sizes associated with the left and right channels. In other words, the decorrelator element may be configured to provide a change in quantized values such as, for example, Huffman coded values, of the left and right channels in accordance with the user selected gain to produce a stereo decorrelated output 82. The stereo decorrelated output 82 may include changed parameters (e.g., quantized values) with respect to the de-multiplexed signal 78 for one or both of the parameters associated with the left and right channels. A more detailed explanation of the stereo decorrelator element 72 according to an exemplary embodiment is included below in connection with FIG. 4.

The multiplexer 74 may be any known multiplexer (MUX) capable of combining several electrical signals into a single signal in accordance with methods known in the art. In an exemplary embodiment, the multiplexer 74 may receive the stereo decorrelated output 82 which may include the separate left and right channels having changed parameters as described above. In response to receipt of the stereo decorrelated output 82, the multiplexer 74 may be configured to combine the separate left and right channels having changed parameters into an output bitstream 84 which includes a compressed stereo signal in which stereo adaptation such as stereo panning has been performed. As such, the output bitstream 84 may also include requantized values for both the left and right channels with respect to the input bitstream 76.

An exemplary embodiment of the present invention will now be described in reference to FIG. 4, which illustrates one more detailed example of an embodiment of the stereo decorrelator element 72. Referring now to FIG. 4, the stereo decorrelator element 72 of an exemplary embodiment may include a bandwidth (BW) limitation element 90, an M/S determiner 92, a requantization element 94, an IS removal element 96, a reducing element 98 and a smoothing element 100. In an exemplary embodiment, each of the bandwidth (BW) limitation element 90, the M/S determiner 92, the requantization element 94, the IS removal element 96, the reducing element 98 and the smoothing element 100 may operate under the control of a processing element. Any processing element described herein may be embodied in many ways. For example, the processing element may be embodied as a processor, a coprocessor, a controller or various other processing means or devices including integrated circuits such as, for example, an ASIC (application specific integrated circuit). In an exemplary embodiment, the processing element could, for example, be the controller 20 of FIG. 1.

Each of the bandwidth (BW) limitation element 90, the M/S determiner 92, the requantization element 94, the IS removal element 96, the reducing element 98 and the smoothing element 100 may be any device or means embodied in either hardware, software, or a combination of hardware and software capable of performing the respective functions associated with each of the corresponding elements as described below. In general terms, according to an exemplary embodiment, the BW limitation element 90 may apply band limitation to the channel under panning (i.e., the channel specified by the user input 80 to be edited) from the de-multiplexed signal 78. Next, a check may be made to determine whether M/S coding is enabled for a frame at the M/S determiner 92. If M/S coding is enabled for the frame, requantization may be performed at the requantization element 94. However, if M/S coding is not enabled, requantization may be skipped. Next, IS coding may be removed at the IS removal element 96. Amplitude values of the panned channel may then be reduced at the reducing element 98 and then finally smoothed at the smoothing element 100.

The BW limitation element 90 may be configured to receive the user input 80 and define a BW limit for the left and/or right channels based on the user input 80. In an exemplary embodiment in which the user input 80 defines a stereo panning gain corresponding to a stereo image shift in a first direction corresponding to one of the channels, the BW limitation element 90 provides the BW limit for the other channel. In other words, for example, if the user defines a stereo image shift left, a decrease in channel amplitude (e.g., a 3 dB reduction) may be defined for the right channel. Alternatively, if the user defines a stereo image shift right, a decrease in channel amplitude may be defined for the left channel. As such, in an exemplary embodiment, the stereo panning gain defines an amount of reduction to the BW and to the quantized values in dB. Accordingly, the BW limitation element 90 provides BW limitation in the channel opposite the channel to which the stereo image shift is desired.

In practice, the input bitstream 76 may be defined as a frequency domain signal x having a length N given by equation (1) below.

x=F(x₁). (1)

In equation (1), x₁ represents a time domain input signal and F( ) denotes time-to-frequency MDCT transformation. For a stereo frame, the signals shown below at (2) are therefore transmitted in the input bitstream 76, and separated by the de-multiplexer 70 to form the de-multiplexed signal 78. Thus, the de-multiplexed signal 78 may include

quant_{left}=Q(F(Lₜ))

quant_{right}=Q(F(Rₜ)) (2)

where Lₜ and Rₜ are time domain left and right channel input signals, respectively, and Q represents a quantization operation that is performed during encoding of the input bitstream 76.

The bandwidth of the panned channel is limited as follows. First, the audio bandwidth of the current frame is determined according to (3) below,

$$audioBw = freq\_resolution \cdot sfbOffset ⌊ {M}_{left / right} ⌋ \\ freq\_resolution = \frac{sampleRate}{2 \cdot N} \qquad ( 3 )$$

in which sfbOffset of length M represents the boundaries of the frequency bands. In an exemplary embodiment, the frequency bands follow the boundaries of the critical bands of the human auditory system. For a stereo signal, both left and right channels may each include their own value of M depending on encoding decisions. However, for M/S coding, the left and right channels share the same value of M. In (3) above, sampleRate represents the sampling rate of the signal in Hz and M_{left/right} represents the maximum number of spectral bands present in the panned channel.

The BW limitation element 90 may also be configured to calculate a target audio bandwidth according to (4) below.

$$audioBwT = audioBw - log 10 ( painGain ) \cdot 10000 \\ audioBwT = \{ \begin{matrix}0 , & audioBwT < 0 \\ audioBwT , & otherwise\end{matrix} \qquad ( 4 )$$

### Finally, the target audio bandwidth is mapped to a new maximum number of spectral bands that are present for the panned channel according to pseudo-code 1 below.

### Pseudo-Code 1:

```
for(sfb = 0, offset = 0; sfb < M_{left/right}; sfb++)
{
  tmp = sfbOffset[sfb+1] * freq_resolution;
  if(tmp > audioBwT)
  {
    /*-- Difference to previous band boundary. --*/
    diff1 = audioBwT − offset * freq_resolution;
    if(diff1 < 0) diff1 = −diff1;
    /*-- Difference to current band boundary. --*/
    diff2 = tmp − audioBwT;
    if(diff2 < 0) diff2 = −diff2;
    if(diff1 < diff2)
      sfb −= 1;
    break;
  }
  offset = sfbOffset[sfb+1];
}
sfb += 1;
if(sfb < 0) sfb = 0;
if(sfb > M_{left/right}) sfb = M_{left/right};
M_{left/right} = sfb;
```

The M/S determiner 92 may be configured to determine whether M/S coding is enabled for a given frame. In an exemplary embodiment, the M/S determiner 92 may be configured to make the determination as to whether M/S coding is enabled based on a bitstream element (e.g., ‘ms_mask_present’). In other words, a characteristic of the bitstream may be indicative of whether M/S coding is enabled, and the M/S determiner 92 may be configured to detect the characteristic.

If M/S coding is enabled for a current frame, fast requantization may be performed at the requantization element 94 which removes stereo correlation as indicated below at (5)

$$\{ \begin{matrix}Apply X , & ms\_used [ sfb ] == ' 1 ' and hCb [ sfb ] < 12 \\ do\_nothing , & otherwise\end{matrix} , 0 \leq sfb < {M}_{LR} [ chIdx ] \\ {M}_{LR} = [ {M}_{left} , {M}_{right} ] \qquad ( 5 )$$

in which hCb represents a Huffman codebook number and ms_used represents a signaling bit of each band, respectively. Huffman codebook numbers below 12 are traditional codebooks where quantized samples are present. Huffman codebook value 13 is used in indicate the presence of perceptual noise substitution (PNS) coding and values 14 and 15 indicate the presence of IS coding. Variable chIdx is set according to (6) below.

$$chIdx \{ \begin{matrix}1 , & left channel panned \\ 0 , & otherwise\end{matrix} \qquad ( 6 )$$

Apply X may be performed utilizing (7) as follows:

$$\{ \begin{matrix}Apply C 1 , & {qMax}_{left} == 0 or {qMax}_{right} == 0 \\ Apply C 2 , & otherwise\end{matrix} \\ {qMax}_{left} = MAX ( \vert {quant}_{left} [ i ] \vert ) \\ {qMax}_{right} = MAX ( \vert {quant}_{right} [ i ] \vert ) \qquad ( 7 )$$

sfbOffset[sfb]≦i<sfbOffset[sfb+1]

Apply C1 may be performed as follows:

$$\{ \begin{matrix}X & {qMax}_{left} == 0 \\ Y & {qMax}_{right} == 0 and sfb < {M}_{right} \\ do\_nothing , & otherwise\end{matrix} \\ X : \\ {sfac}_{left} [ sfb ] = {sfac}_{right} [ sfb ] \\ {quant}_{left} [ i ] = {quant}_{right} [ i ] \\ {quant}_{right} [ i ] = - {quant}_{right} [ i ] \qquad ( 8 )$$

### Y:

sfac_{right}[sfb]=sfac_{left} [sfb]

quant_{right}[i]=quant_{left}[i]

sfbOffset[sfb]≦i<sfbOffset[sfb+1]

where sfac is the quantizer step size of the corresponding channel.
Apply C2 may be performed as follows:

$lr = \{ \begin{matrix}0 , & {sfac}_{left} [ sfb ] > {sfac}_{right} [ sfb ] \\ 1 , & otherwise\end{matrix} \\ if {sfac}_{left} [ sfb ] > {sfac}_{right} [ sfb ] \\ dScale = {2}^{0.25 \cdot ( {sfac}_{left} [ sfb ] - {sfac}_{right} [ sfb ] )} \\ {sfac}_{right} [ sfb ] = {sfac}_{left} [ sfb ] \\ else \\ dScale = {2}^{0.25 \cdot ( {sfac}_{right} [ sfb ] - {sfac}_{left} [ sfb ] )} \\ {sfac}_{left} [ sfb ] = {sfac}_{right} [ sfb ] \\ sfbStopL = \{ \begin{matrix}0 , & sfb < {M}_{L} \\ 1 , & otherwise\end{matrix} \\ sfbStopR = \{ \begin{matrix}0 , & sfb < {M}_{R} \\ 1 , & otherwise\end{matrix} \qquad ( 9 )$
for(j = sfbOffset[sfb]; j < sfbOffset[sfb+1]; j++)
{

if(sfbStopL)

quant_{left}[j] = 0;

if(sfbStopR)

quant_{right}[j] = 0;

ReQuantBins(&quant_{left}[j], &quant_{right}[j], lr, dScale);

}

After the requantization element 94 removes stereo correlation as indicated above at (5) through (9), fast requantization may be achieved according to pseudo-code 2 below.

### Pseudo-Code 2:

ReQuantBins(int16 *x, int16 *y, isRight, scale)
{

if(!(*x = = 0 && *y = = 0) )
{

if(*x = = 0 && *y != 0)
{

if(!isRight)
{

scale *= *y;
scale += (*y > 0) ? 0.5f : −0.5f;
*x = (int16) scale;
*y = −*x;

}
else
{

*x = *y;
*y = −*y;

}

}
else if(*x != 0 && *y = = 0)
{

if(isRight)
{

scale *= *x;
scale += (*x > 0) ? 0.5f : −0.5f;
*x = (int16) scale;
*y = *x;

}
else

*y = *x;

}
else
{

x2 = Pow43(*x, powTable);
y2 = Pow43(*y, powTable);
if(isRight)
{

scale *= x2;
tmp = (int16) (scale + y2);
Pow34(&tmp, 1);
*x = (int16) tmp;
tmp = (int16) (scale − y2);
Pow34(&tmp, 1);
*y = (int16) tmp;

}
else
{

scale *= y2;
tmp = (int16) (x2 + scale);
Pow34(&tmp, 1);
*x = (int16) tmp;
tmp = (int16) (x2 − scale);
Pow34(&tmp, 1);
*y = (int16) tmp;

}

}

}

}
where
$Pow 43 ( x ) = \{ \begin{matrix}{\vert x \vert}^{\frac{4}{3}} , & x \geq 0 \\ - {\vert x \vert}^{\frac{4}{3}} , & otherwise\end{matrix} \\ Pow 34 ( x ) = \{ \begin{matrix}⌊ {\vert x \vert}^{\frac{3}{4}} ⌋ , & x \geq 0 \\ ⌊ - {\vert x \vert}^{\frac{3}{4}} ⌋ , & otherwise\end{matrix} \qquad ( 10 )$

The typical dynamic range of the quantized samples is less than 256. Thus, efficient implementations of equation (10) can be achieved by calculating power values offline and storing the results to internal tables. As an example, a pre-determined maximum number of values could be calculated (e.g., 256). Indexing the internal tables at a later time may be faster than calculating the values during stereo decorrelation. However, in infrequent situations in which the calculated value happens to be larger than the size of the internal table, a normal function call may be utilized. Exemplary simulations have been conducted in which table indexing is sufficient about 95% of the time. Furthermore, the size of the table can be doubled or the size of the table reduced to half by storing only every second value and linearly interpolating the missing value. Inaccuracies associated with interpolation compared to original values are small and can be viewed as round-off effect. Accordingly, interpolation generally has a relatively small, if any, impact on output quality.

The IS removal element 96 may be configured to remove IS coding. In an exemplary embodiment, the IS coding is removed as follows as shown in equation (11).

$${sfac}_{right} [ sfb ] = \{ \begin{matrix}{sfac}_{left} [ sfb ] - 2 \cdot {sfac}_{right} [ sfb ] , & hCb [ sfb ] == IS\_STEREO \\ {sfac}_{left} [ sfb ] , & otherwise\end{matrix} \\ {quant}_{right} [ i ] = \{ \begin{matrix}{quant}_{left} [ i ] , & hCb [ sfb ] == IS\_STEREO \\ unchanged , & otherwise\end{matrix} , sfbOffset [ sfb ] \leq i < sfbOffset [ sfb + 1 ] \qquad ( 11 )$$

### In an exemplary embodiment, equation (11) is repeated for 0≦sfb<M_{right}.

The reducing element 98 is configured to reduce amplitude values of the panned channel in accordance with the user input 80 (e.g., the panning gain). In this regard, the reduction of selected quantized values may be performed according to equation (12) below as follows

$${quant}_{left / right} [ i ] = \{ \begin{matrix}A , & \vert {quant}_{left / right} [ i ] \vert < qMAX - 1 \\ unchanged , & otherwise\end{matrix} , sfbOffset [ sfb ] \leq i < sfbOffset [ sfb + 1 ] \\ where \\ A = sign ( {quant}_{left / right} [ i ] ) \cdot ⌊ {gain}_{pain} \cdot \vert {quant}_{left / right} [ i ] \vert + 0.1 ⌋ \\ {gain}_{pain} = {( {10}^{- 0.1 \cdot panGain} )}^{0.75} \\ sign ( x ) = \{ \begin{matrix}- 1 , & X < 0 \\ 1 , & otherwise\end{matrix} \\ qMax = Max ( \vert {quant}_{left / right} [ i ] \vert ) , sfbOffset [ sfb ] \leq i < sfbOffset [ sfb + 1 ] \qquad ( 12 )$$

where panGain is the panning gain of the selected channel in dB scale. Equation (12) may be repeated for 0≦sfb<M_{left/right}. When M/S coding is enabled, an additional 0.4 dB gain may also be applied to gainₚₐₙ.

The smoothing element 10 may then be configured to smooth the amplitude values. In an exemplary embodiment, spectral smoothing may be performed using equation (13) below.

$${quant}_{left / right} [ i ] = ⌊ {scale}^{i - sfbOffset [ sfb ]} \cdot {quant}_{left / right} [ i ] ⌋ , sfbOffset [ sfb ] \leq i < sfbOffset [ sfb + 1 ] \qquad ( 13 )$$

### Equation (13) may be repeated for M_{right}−1≦sfb<M_{right} and, in an exemplary embodiment, scale may be set to a selected value such as 0.9 in the present example.

Although the above implementation of an embodiment of the present invention has been described in the context of performing stereo panning on a single channel, it should be noted that stereo panning may also be performed on more than one channel. In such an embodiment, the elements of FIG. 4 may be duplicated into parallel processes. Additionally, although an exemplary embodiment above has been described in the context of M/S and/or IS coding, other exemplary embodiments are also applicable to other perceptual audio coding algorithms such as MPEG-1 (moving picture experts group) Layer III (MP3) and Windows Media Audio (WMA).

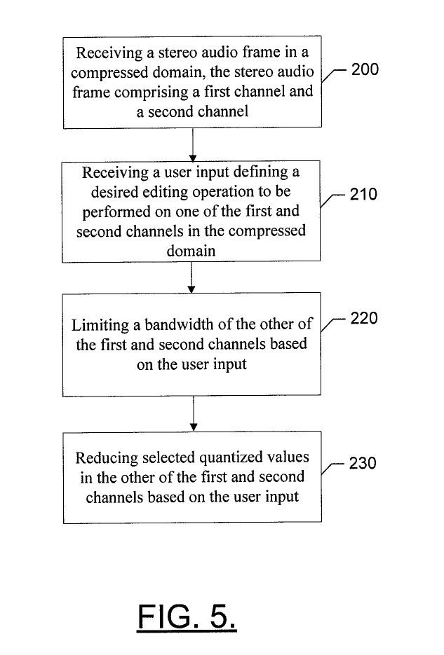

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing stereo adaptation for audio editing includes receiving a stereo audio frame in a compressed domain at operation 200. The stereo audio frame may include a first channel and a second channel. The method may also include receiving a user input defining a desired editing operation to be performed on one of the first and second channels in the compressed domain at operation 210. In an exemplary embodiment, the user input may be a stereo panning gain. At operation 220, a bandwidth of the other of the first and second channels may be limited based on the user input. In an exemplary embodiment, limiting the bandwidth may include determining a target bandwidth, and mapping the target bandwidth to a selected number of spectral bands. The method may also include reducing selected quantized values in the other of the first and second channels based on the user input at operation 230. Exemplary embodiments of the method may also include performing a fast requantization on the other of the first and second channels in response to a determination that data associated with the other of the first and second channels has been encoded using M/S (Mid/Side) encoding after limiting the bandwidth. In an exemplary embodiment, the calculations associated with the fast requantization may be performed offline and results of the calculations may be stored for indexing during online processing. The method above may also include performing an Intensity Stereo (IS) removal prior to reducing the selected quantized values and/or performing a smoothing of the selected quantized values.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. Additionally, it should be noted that although the preceding descriptions refer to modules, it will be understood that such term is used for convenience and thus the modules above need not be modularized, but can be integrated and code can be intermixed in any way desired.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving a stereo audio frame in a compressed domain, the stereo audio frame comprising a first channel and a second channel;
receiving a user input defining a desired editing operation to be performed with respect to one of the first and second channels in the compressed domain; and
limiting a bandwidth of the other of the first and second channels based on the user input.

2. A method according to claim 1, wherein receiving the user input comprises receiving a stereo panning gain and wherein limiting the bandwidth is performed based on the stereo panning gain.

3. A method according to claim 1, further comprising performing a fast requantization on the other of the first and second channels in response to a determination that data associated with the other of the first and second channels has been encoded using M/S (Mid/Side) encoding after limiting the bandwidth.

4. A method according to claim 3, further comprising performing calculations associated with the fast requantization offline and storing results of the calculations for indexing.

5. A method according to claim 1, further comprising reducing selected quantized values in the other of the first and second channels based on the user input.

6. A method according to claim 5, further comprising performing an Intensity Stereo (IS) removal prior to reducing the selected quantized values.

7. A method according to claim 5, further comprising performing a smoothing of the selected quantized values.

8. A method according to claim 1, wherein limiting the bandwidth comprises:
determining a target bandwidth; and
mapping the target bandwidth to a selected number of spectral bands.

9. A computer program product comprising at least one computer-readable storage medium having computer-readable program code portions stored therein, the computer-readable program code portions comprising:
a first executable portion for receiving a stereo audio frame in a compressed domain, the stereo audio frame comprising a first channel and a second channel;
a second executable portion for receiving a user input defining a desired editing operation to be performed with respect to one of the first and second channels in the compressed domain; and
a third executable portion for limiting a bandwidth of the other of the first and second channels based on the user input.

10. A computer program product according to claim 9, wherein the second executable portion includes instructions for receiving a stereo panning gain and wherein limiting the bandwidth is performed based on the stereo panning gain.

11. A computer program product according to claim 9, further comprising a fourth executable portion for performing a fast requantization on the other of the first and second channels in response to a determination that data associated with the other of the first and second channels has been encoded using M/S (Mid/Side) encoding after limiting the bandwidth.

12. A computer program product according to claim 11, further comprising a fifth executable portion for performing calculations associated with the fast requantization offline and storing results of the calculations for indexing.

13. A computer program product according to claim 9, further comprising a fourth executable portion for reducing selected quantized values in the other of the first and second channels based on the user input.

14. A computer program product according to claim 13, further comprising a fifth executable portion for performing an Intensity Stereo (IS) removal prior to reducing the selected quantized values.

15. A computer program product according to claim 13, further comprising a fifth executable portion for performing a smoothing of the selected quantized values.

16. A computer program product according to claim 9, wherein the third executable portion includes instructions for:
determining a target bandwidth; and
mapping the target bandwidth to a selected number of spectral bands.

17. An apparatus comprising a stereo decorrelator configured to receive a stereo audio frame in a compressed domain, the stereo audio frame comprising a first channel and a second channel, the stereo decorrelator including a bandwidth limitation element configured to:
receive a user input defining a desired editing operation to be performed with respect to one of the first and second channels in the compressed domain; and
limit a bandwidth of the other of the first and second channels based on the user input.

18. An apparatus according to claim 17, wherein the bandwidth limitation element is configured to receive a stereo panning gain and limit the bandwidth based on the stereo panning gain.

19. An apparatus according to claim 17, wherein the decorrelator element further comprises a requantization element configured to perform a fast requantization on the other of the first and second channels in response to a determination that data associated with the other of the first and second channels has been encoded using M/S (Mid/Side) encoding.

20. An apparatus according to claim 19, wherein the requantization element is configured to perform calculations associated with the fast requantization offline and store results of the calculations for indexing.

21. An apparatus according to claim 17, wherein the decorrelator element further comprises a reducing element configured to reduce selected quantized values in the other of the first and second channels based on the user input.

22. An apparatus according to claim 21, wherein the decorrelator element further comprises an Intensity Stereo (IS) removal element configured to remove IS coding prior to reducing the selected quantized values.

23. An apparatus according to claim 21, wherein the decorrelator element further comprises a smoothing element configured to smooth the selected quantized values.

24. An apparatus according to claim 17, wherein the bandwidth limitation element is configured to:
determine a target bandwidth; and
map the target bandwidth to a selected number of spectral bands.

25. An apparatus according to claim 17, wherein the apparatus is embodied as a mobile terminal.

26. An apparatus comprising:
means for receiving a stereo audio frame in a compressed domain, the stereo audio frame comprising a first channel and a second channel;
means for receiving a user input defining a desired editing operation to be performed with respect to one of the first and second channels in the compressed domain; and
means for limiting a bandwidth of the other of the first and second channels based on the user input.
